(19) United States
(12) Patent Application Publication
(10) Pub. No.: US 2013/0206012 A1
(43) Pub. Date: Aug. 15, 2013

(54) Percolation Device

(71) Applicants: Gilles Morin, Varios et Chaignot (FR); Romain Turpin, Sainte Honorine du Fay (FR)

(72) Inventors: Gilles Morin, Varios et Chaignot (FR); Romain Turpin, Sainte Honorine du Fay (FR)

(21) Appl. No.: 13/143,718

(22) PCT Filed: Jan. 6, 2010
(86) PCT No.: PCT/FR2010/050009

§ 371 Date: Oct. 17, 2011

(30) Foreign Application Priority Data
Jan. 8, 2009 (FR) 0950089

(51) Int. Cl. A47J 31/36

(52) U.S. Cl. CPC A47J 31/3609
USPC 99/287

(57) ABSTRACT

The present invention relates to a percolation device (1) that comprises a percolation chamber, as well as a base (2) in which the following are provided: an axial discharge outlet (8); a sleeve (3) that is axially movable and which has an axial ejection outlet (16); an axially movable compression surface (18) which, with a packing head (10) axially defining the discharge outlet (8), axially defines the percolation chamber; and a lever (5) for driving, in a differentiated manner, the sleeve (3) and the compression surface (18) such that, when the sleeve (3) is in a position in which it releases from the discharge outlet (8), the grounds, driven out of the sleeve (3) by means of the ejection outlet (16) through the compression surface (18), are in line with the discharge outlet (8).

This invention relates to a percolation device, and more particularly, a device making it possible to realise coffee in the form of a drink using loose grounds (i.e. non packaged in pods), either in the form of a powder (coming from ground beans), or in the form of a tablet (coming from a compression of powder).

Percolation devices are known for the general public making it possible to make coffee of the espresso type using grounds packaged in pods, these devices have the advantage of being able to be used very easily. However their major disadvantages reside in the very fact of using pods. Each percolation device can accept only a single type of pods coming from an exclusive supplier. Therefore, the prices are relatively high (in any case, higher than those for grounds usually sold in superstores), and the choice of grounds is rather limited (in any case, it cannot meet the requirements of coffee lovers who usually purchase from coffee roasters). In addition, the packaging of each pod also gives rise to an environmental problem.

It is known moreover, in particular according to application FR 2 671 960, a percolation device comprising a percolation chamber for the percolation of loose coffee grounds, the device comprising a base wherein is carried out a discharge outlet for the expulsion of the used grounds out of the percolation chamber, a sleeve comprising an axial ejection outlet for the expulsion of the grounds out of the percolation chamber and mobile according to an axial direction between at least one percolation position wherein it obstructs the discharge outlet and an ejection position wherein it releases it, a packing head adjacent to the ejection outlet and axially delimiting the percolation chamber and the discharge outlet, a compression member comprising a compression surface which axially delimits the percolation chamber opposite the packing head and mobile axially between an intake position and a percolation position wherein it is closer to the packing head than when it is in its intake position, and an activation member mobile between an intake position and a percolation position.

Yet such an apparatus is particularly complex, voluminous, in particular because of its motorisation and of the realisation of the driving of the sleeve and of the compression member by guiding grooves made in a worm screw.

This invention aims to carry out a percolation device for loose grounds which is as simple to use and taking up as little space as a percolation device for grounds in a pod.

According to the invention, the activation member is formed by a lever which, in particular during its back-and-forth movement formed by its displacement from its intake position to its percolation position then via the inverse displacement, is adapted to drive in a differentiated manner the movement of the sleeve and that of the compression member in such a way that, when the sleeve is in its ejection position, the grounds, driven out of the sleeve via the ejection outlet by the compression surface, are in line with the discharge outlet.

Such a device having such a simple activation member allows any user to make coffee as a drink using a simple back-and-forth movement carried out by this member during which, in a first step, the grounds are compressed in the percolation chamber, in a second step, the water under pressure is injected into this chamber producing the drink, and in a third step, the coffee grounds are ejected from this chamber.

Other advantages and particularities of this invention shall appear in the description of three embodiments given by way of non-restricted examples and shown in the annexed drawings wherein:

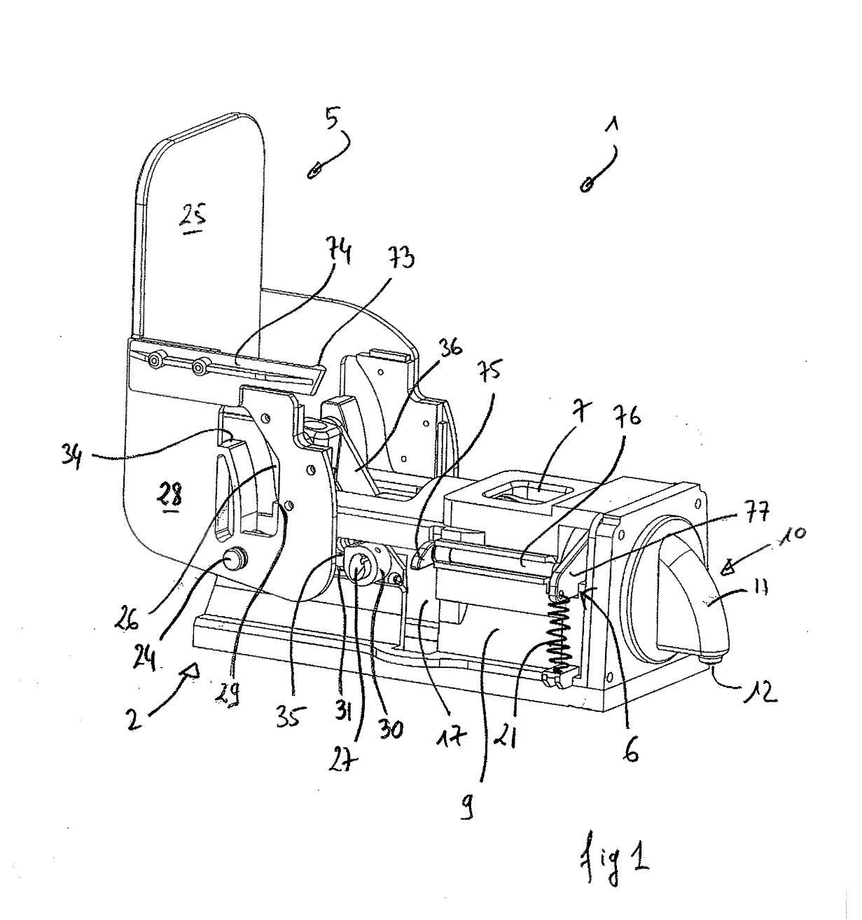

FIG. 1 is a perspective view of a percolation device in accordance with a first embodiment, the activation member being in its intake position,

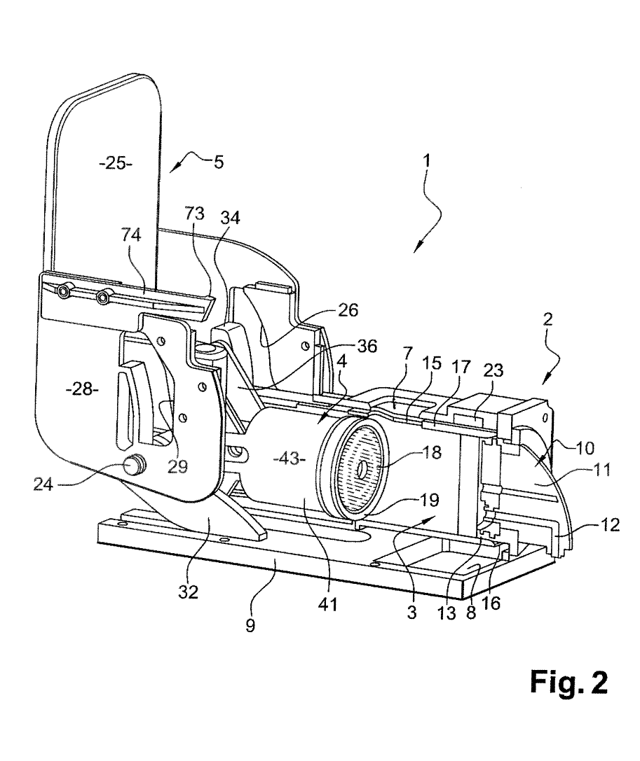

FIG. 2 is a view similar to FIG. 1, with the base and the sleeve in a cross-section in order to allow for the viewing of the compression member and of the means connecting it to the activation member,

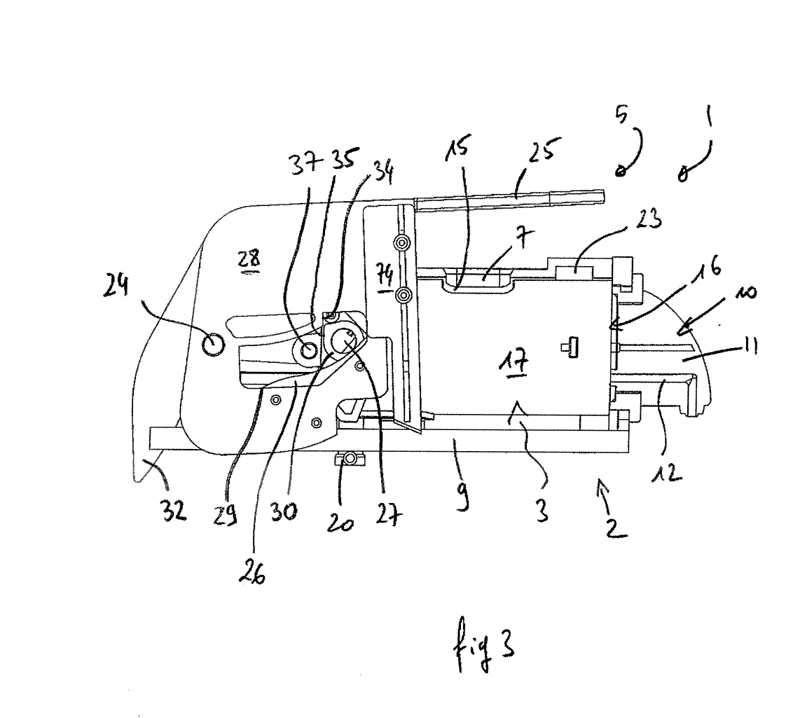

FIG. 3 is a lateral view of the percolation device wherein the base is in a cross-section in order to allow for the viewing of the sleeve and its connection with the activation member, with the latter being almost in percolation position,

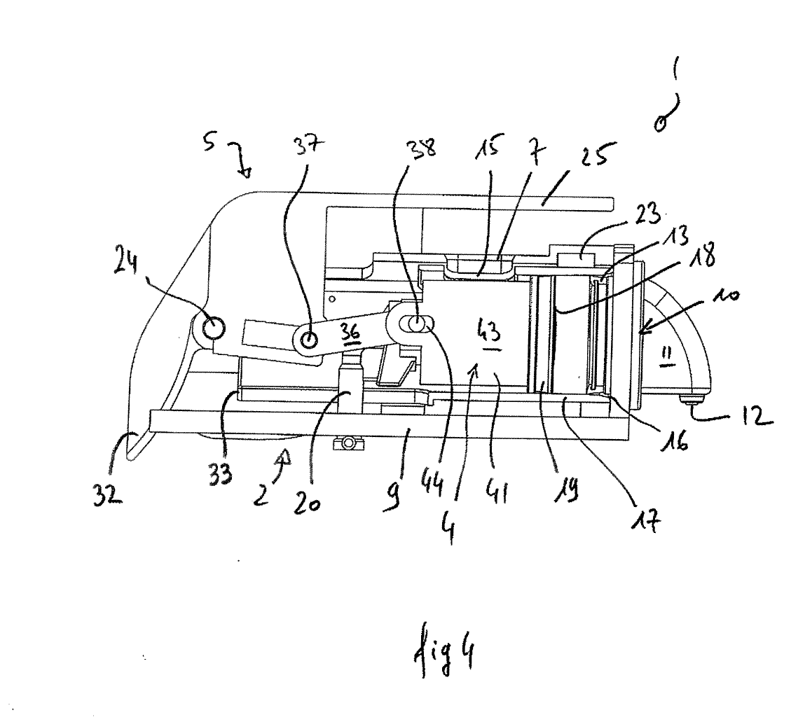

FIG. 4 is a lateral view of the percolation device wherein the base and the sleeve are in a cross-section in order to allow for the viewing of the compression member and its connection with the activation member, with the latter being in percolation position,

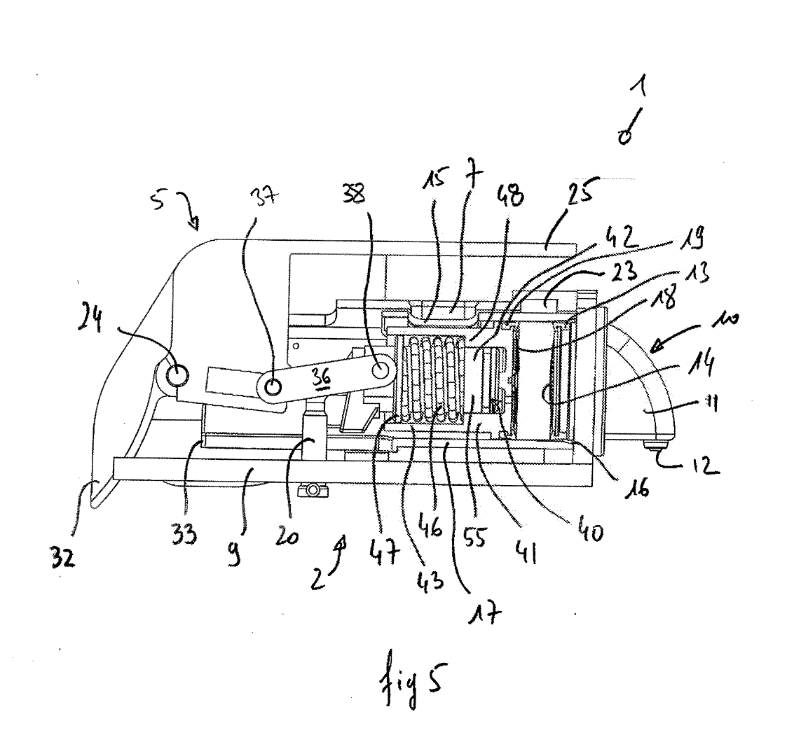

FIG. 5 is a lateral view of the percolation device wherein the base, the sleeve and the packing sleeve which is part of the compression member are in a cross-section in order to allow for the viewing of the injection nozzle which is the additional portion of the compression member and which is surrounded by the packing sleeve, the activation member being in percolation position,

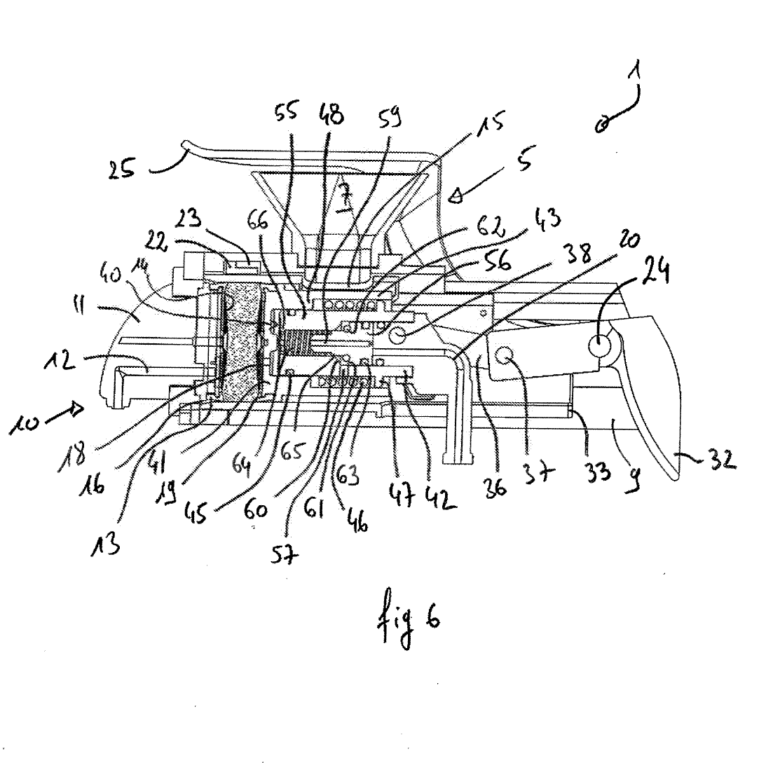

FIG. 6 is a lateral cross-section view of the percolation device wherein the sleeve, the compression member and the activation member are in the same position as in FIG. 5, the packing sleeve being in a packing position adjusted to the quantity of grounds, and the valve which is part of the injection nozzle being in opened position,

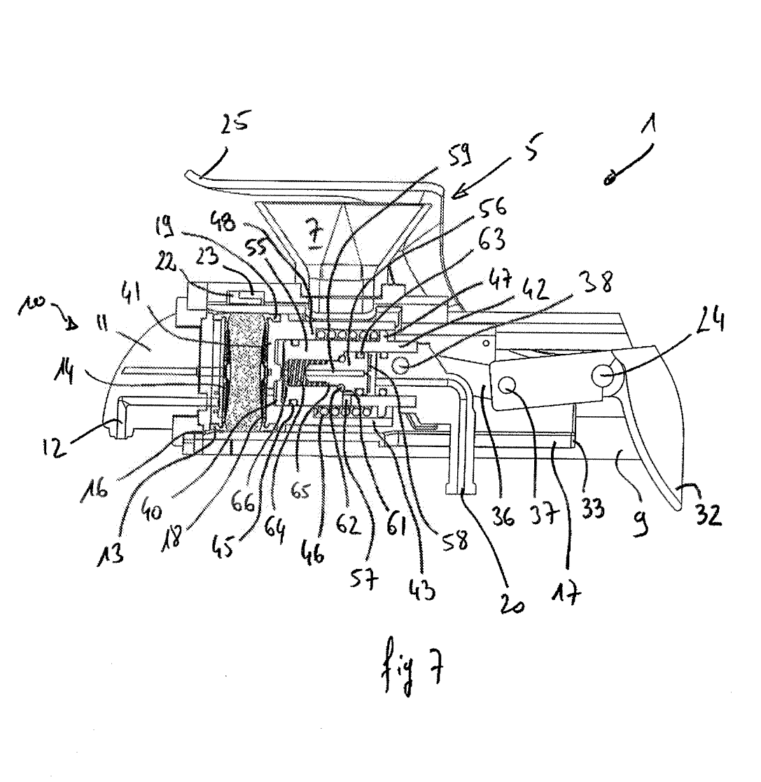

FIG. 7 is a view similar to FIG. 6, with the valve in closed position,

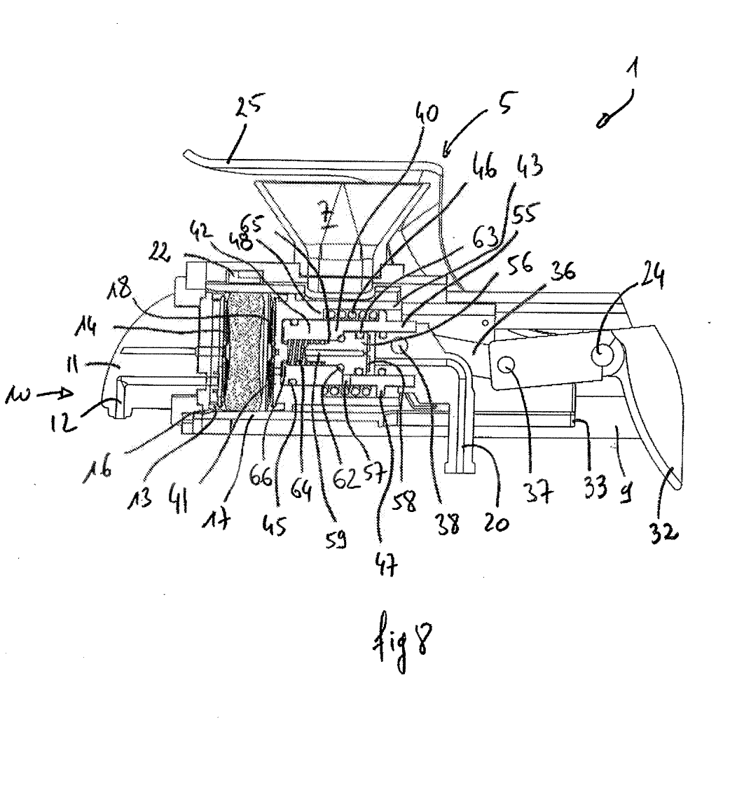

FIG. 8 is a view similar to FIG. 7, the packing sleeve being in percolation position,

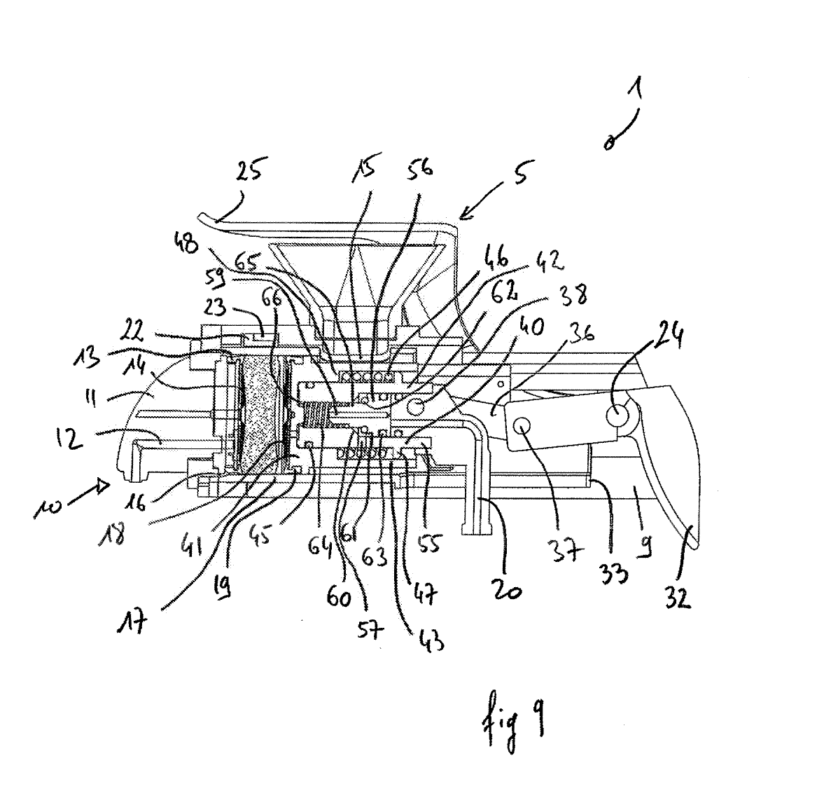

FIG. 9 is a view similar to FIG. 8, the valve being in opened position,

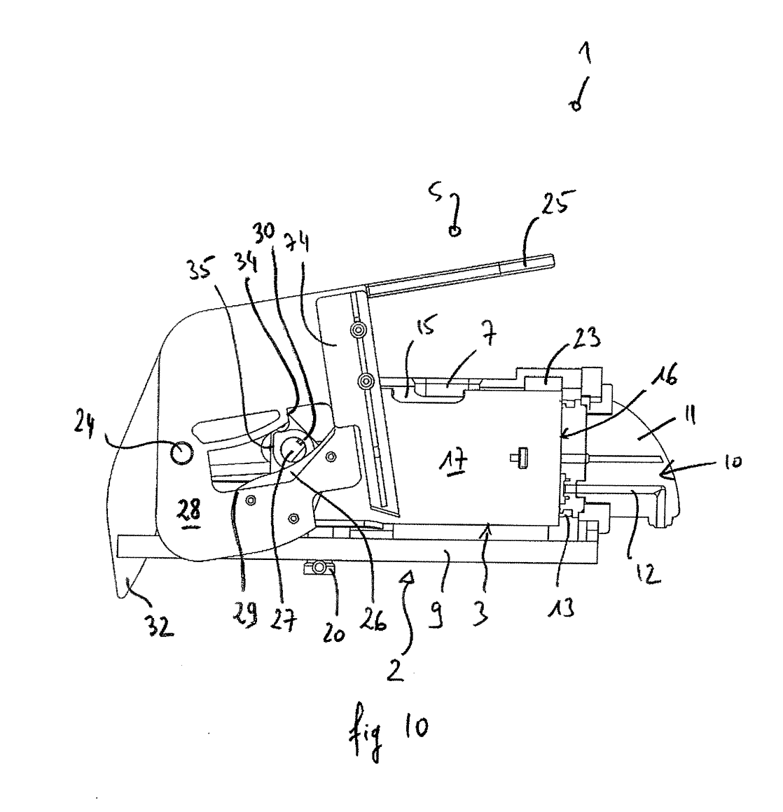

FIG. 10 is a view similar to FIG. 3 wherein the activation member has just left its percolation position and the sleeve is driven towards its ejection position,

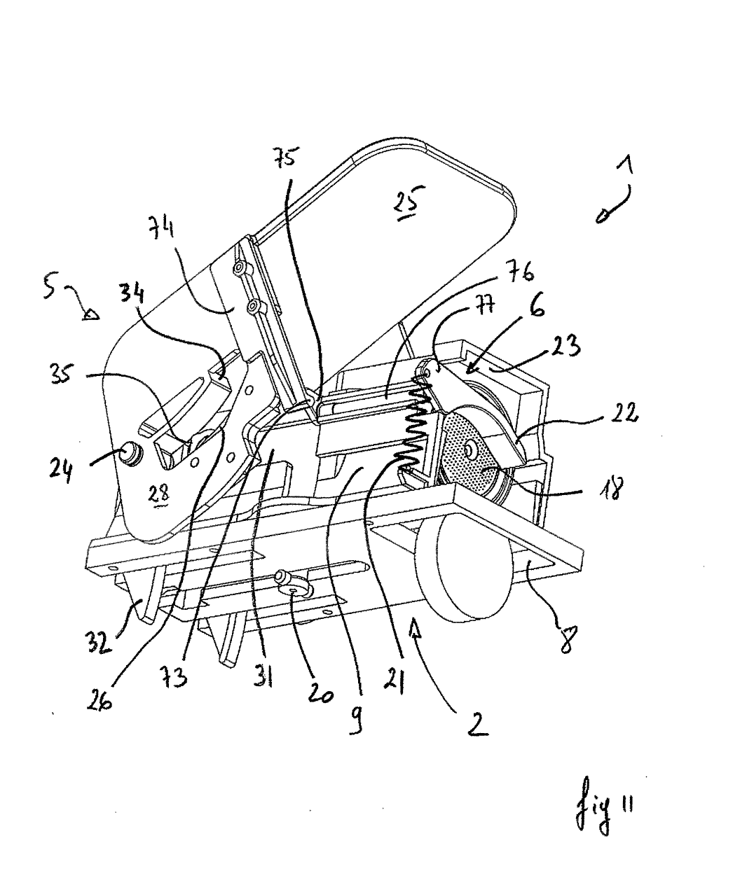

FIG. 11 is a perspective bottom view wherein the activation member is in its ejection position, the packing head not being shown,

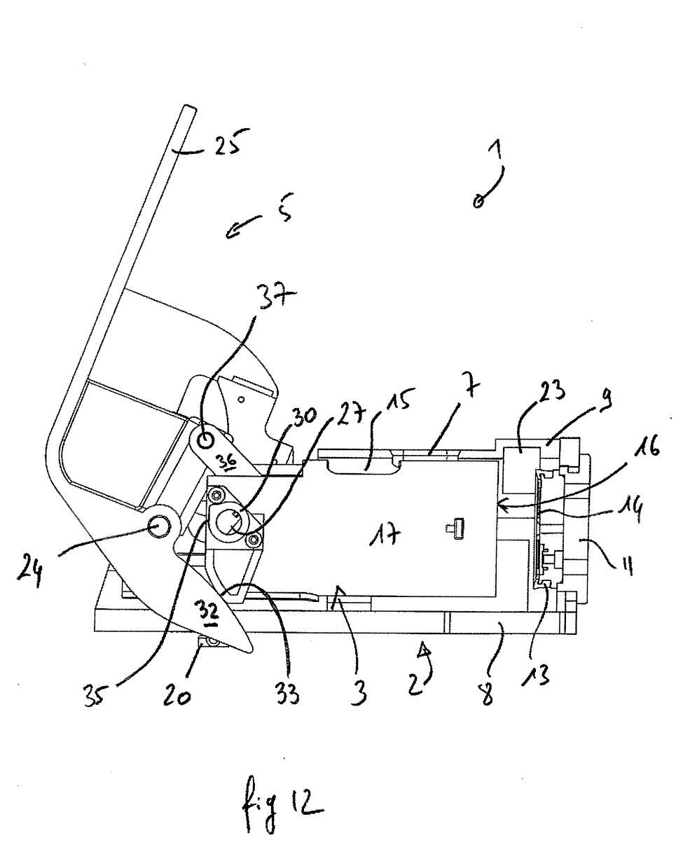

FIG. 12 is a view similar to FIG. 10 wherein the activation member arrives in its intake position and the sleeve is driven towards its percolation position,

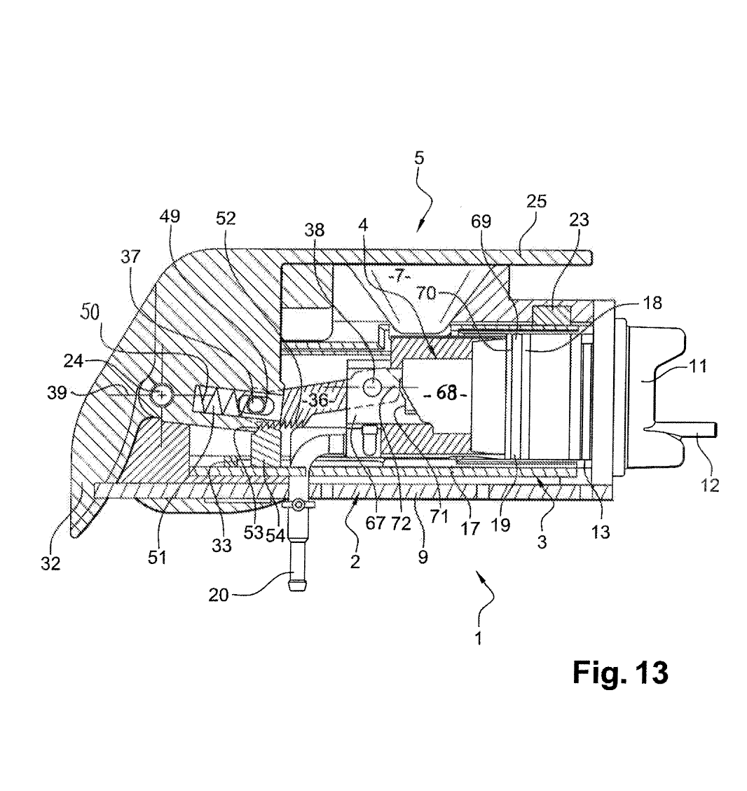

FIG. 13 is a view similar to FIG. 4 showing a percolation device according to a second embodiment, and

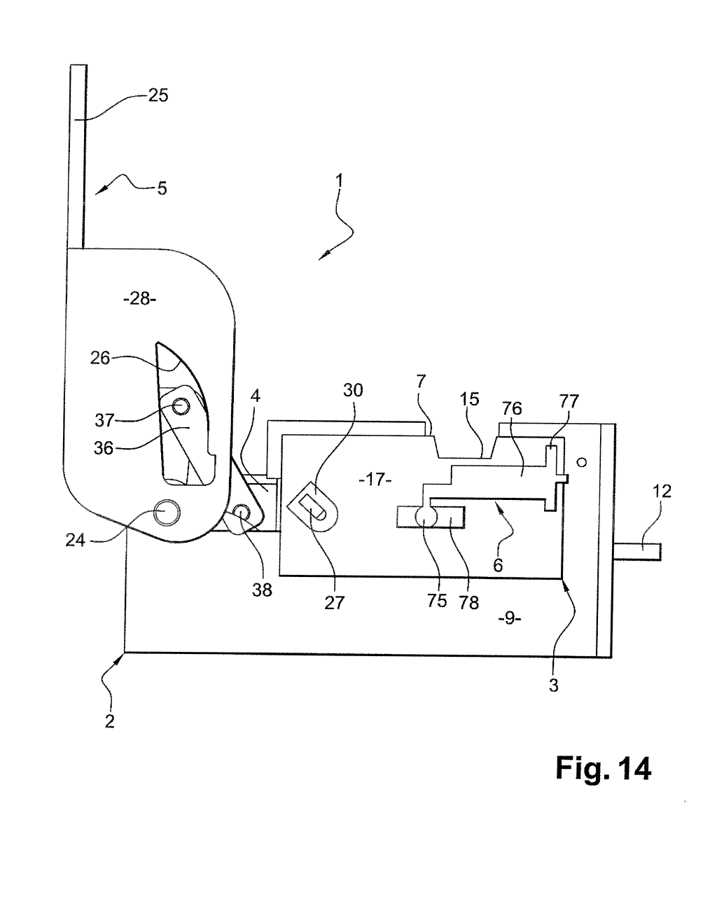

FIG. 14 is a view similar to FIG. 3 showing a percolation device according to a third embodiment.

As shown in the various figures, a percolation device 1 for loose coffee grounds comprises a base 2, a sleeve 3 movable in relation to the base 2, a compression member 4 movable in relation to the base 2 and to the sleeve 3 and an activation member 5 movable in relation to the base 2, to the sleeve 3 and to the compression member 4. Furthermore, in these embodiments, the percolation device 1 further comprises an ejector 6 movable in relation to the base 2, to the sleeve 3, to the compression member 4 and to the activation member 5.

The base 2 delimits a working chamber (here of cylindrical shape) wherein the sleeve 3 is mounted slidingly (according to the axis of the working chamber), the straight section of the working chamber corresponding to that of the sleeve 3 in such a way that its translation movement is its only degree of freedom. The working chamber is accessible from the exterior via an upper introduction inlet 7 through which the coffee grounds can be introduced into the chamber, and a lower discharge outlet 8 through which the used grounds can exit therefrom.

In these examples, the base 2 comprises, on the one hand, a casing 9 which radially delimits the working chamber, and, on the other hand, a packing head 10 which forms an axial delimitation of the chamber. In this embodiment, the grounds introduction inlet 7 and the grounds discharge outlet 8 are made in the casing 9, with this latter outlet 8 being moreover delimited by the packing head 10.

In addition, in these embodiments, in order to facilitate the cleaning of the working chamber, the packing head 10 is mounted in a movable manner in relation to casing 9. Furthermore, it comprises a tip 11 which forms the body of the head 10 and which is adapted to be fixed to the casing 9 in such a way as to obstruct the axial outlet of the latter. The tip 11 comprises on the one hand, a drink evacuation duct 12 which crosses it and which allows the exiting of the liquid coffee obtained by percolation, and, on the other hand, a peripheral groove wherein is mounted a seal 13. The packing head 10 further comprises a coffee filter 14 which is fixed against the tip 11 and which forms the axial limit of the working chamber (cf. FIGS. 2 and 7).

The sleeve 3 delimits a compression chamber (here, of cylindrical shape) wherein the compression member 4 is mounted slidingly (according to the axis of the compression chamber), the straight section of the compression chamber corresponding to that of the compression member 4 in such a way that its translation movement is its only degree of freedom. The compression chamber is accessible via an upper grounds intake outlet 15 through which the grounds can be introduced into the chamber, and an axial ejection outlet 16 through which the used grounds can exit therefrom.

The sleeve 3 is mounted mobile in the casing 9 between at least one percolation position and an ejection position. In percolation position, the sleeve obstructs the grounds discharge outlet 8 and the grounds intake outlet 15 extends the grounds introduction inlet 7 in such a way that the compression chamber is accessible from the exterior. In ejection position, the sleeve 3 releases the discharge outlet 8.

In these examples, the sleeve 3 comprises a hollow cylinder 17 which radially delimits the compression chamber and wherein is carried out the intake outlet 15. The axial end of the cylinder 17 which is adjacent to the packing head 10, on the one hand, delimits the ejection outlet 16, and on the other hand, obstructs the discharge outlet 8 when the sleeve 3 is in percolation position and releases it when the sleeve 3 is in ejection position. Furthermore, when the sleeve 3 is in percolation position, this axial end of the cylinder 17 is arranged in an annular groove delimited by the casing 9 and the tip 11, the seal being provided by the seal 13.

The compression member 4 is mounted mobile in the cylinder 17 (and therefore in the casing 9) between a percolation position and an intake position. The portion of the compression chamber which is delimited axially, on the one hand, by the packing head 10, and, on the other hand, by the compression member 4, forms a percolation chamber wherein the grounds are compressed and wherein the percolation takes place. More precisely, the percolation chamber is delimited by a compression surface 18 which is the axial surface of the compression member 4 coming into contact with the grounds. In intake position, the introduction outlet 7 exits into the percolation chamber (it is axially arranged between the compression member 4 and the packing head 10). When the compression member 4 is in percolation position, the grounds are compressed, and, in this embodiment, the entire percolation chamber is located in line with the discharge outlet 8. When at the same time the compression member 4 is in its percolation position and the sleeve 3 is in its ejection position, the compression surface 18 is out of the cylinder 17 or on the ejection outlet of the grounds 16.

Moreover, in order to guarantee the seal of the percolation chamber, the compression member 4 comprises, at its periphery, a seal 19. The compression member 4 further comprises a system for injecting water under pressure making possible the realisation of the coffee in the form of a drink. This system comprises, on the one hand, a water injection sprayer which forms the compression surface 18 and which makes possible the introduction of the water into this chamber, and, on the other hand, a water feed duct 20 which is fixed to the compression member 4 via its axial face opposite the compression surface 18 (the face located outside of the percolation chamber).

The ejector 6 is carried by the base 2 (by the casing 9) and is mounted mobile (here in rotation) between an ejection position and an idle position. In ejection position, the ejector 6 ejects the grounds out of the percolation device 1 via the discharge outlet 8 which is released by the sleeve 3 in ejection position. In these embodiments, the ejector 6 is solicited in its idle position by an elastic element 21 (here, a return spring 21). More precisely, the ejector 6 comprises an ejection prong 22 which, when the ejector 6 is in its idle position, is arranged in a housing 23 made in the casing 9, in line with the discharge outlet 8. In these embodiments, the ejection prong 22 drives the grounds via the discharge outlet 8 when these grounds are out of the cylinder 17 due to the relative position of the sleeve 3 and of the compression surface 18.

The activation member 5 is mobile between an intake position and a percolation position and is adapted to drive the movement of the sleeve 3 and of the compression member 4 as well as, in this embodiment, the ejector 6.

Here, the activation member 5 is formed by a lever 5 which is mounted in rotation in relation to base 2 around a main shaft 24 (here, fixed), located opposite the packing head 10. In these examples, the lever 5 comprises an actuating wing 25 which forms the manual control member and which, when the lever 5 is in its percolation position, is substantially horizontal and covers the introduction outlet 7, and, when the lever 5 is in its intake position, is substantially vertical and releases this outlet 7.

The lever 5 is shaped in such a way that, when it passes from its intake position to its percolation position, firstly, it drives the compression member 4 from its intake position to its percolation position, secondly, it leaves the sleeve 3 in its percolation position, and thirdly, it leaves the ejector 6 in its idle position. On the other hand, when it passes from its percolation position to its intake position, firstly, it drives the compression member 4 from its percolation position to its intake position, secondly, it drives the sleeve 3 in a back-and-forth movement from its percolation position to its percolation position by passing through its ejection position, and thirdly, it drives the ejector 6 in a back-and-forth movement from its idle position to its idle position by passing through its ejection position (here, it drives the ejector from its idle position to its ejection position then releases it, leaving the return spring 21 drive it to its idle position).

In relation to the driving of the sleeve 3, the lever 5 comprises two driving elements, one for the movement of the sleeve 3 from the percolation position to its extreme back-and-forth position, the other for the reverse movement.

In these embodiments, in order to drive the sleeve 3 from the percolation position to its extreme back-and-forth position, the lever 5 comprises at least one (here, two) selective fixing member 26 which is adapted to cooperate with an additional selective fixing member 27 carried by the sleeve 6. More precisely, when the lever 5 passes from its percolation position to its intake position, in a first step, the additional selective fixing member 27 is fixed to the selective fixing member 26 (which drives the displacement of the sleeve 3 from its percolation position to its extreme back-and-forth position), and in a second step it is released therefrom. As such, the lever 5 passes through a release position wherein the additional selective fixing member 27 becomes released from the selective fixing member 26 and wherein the sleeve 3 is in its extreme back-and-forth position. And when the lever 5 passes from its intake position to its percolation position, in a first step, the additional selective fixing member 27 is released from the selective fixing member 26, and in a second temps it is fixed thereto. As such, the lever 5 passes through a position of fixing wherein the additional selective fixing member 27 becomes fixed to the selective fixing member 26.

Here, each selective fixing member 26 is a rib 26 forming a cam surface and carried by a lateral wing 28 of the lever 5. The two lateral wings 28 are pendant from the actuating wing 25, oriented in a substantially vertical manner, and arranged on either side of the casing 9. The longitudinal end 29 of each rib 26 adjacent to the main shaft 24 defines the extreme back-and-forth position of the sleeve 3 and the release position of the lever 5. In parallel, each of the two additional selective fixing members 27 is formed by a lug 27 which is mounted mobile in relation to the sleeve 3 between a retracted position allowing it to be fixed to the corresponding rib 26, and a deployed position wherein it is adapted to receive the thrust rib 26 in such a way as to be fixed to it. Here, each lug 27 is solicited in its deployed position by a deployment spring. The corresponding contact surfaces of the lugs 27 and of the ribs 26 are shaped in such a way that the fixing is carried out by the crossing of each rib 26 and the consecutive snapping of the corresponding lug 27, and that, fixed, each lug 27 is thrust against the upper surface of the corresponding rib 26 by the displacement of the lever 5. More precisely, each lug 27 is mounted mobile in a base 30 which protrudes from cylinder 17 (and which is therefore a part of the sleeve 3) and which crosses a guiding slot 31 made in the casing 9. As such, each base 30 is mounted slidingly in an imprisoned manner in the corresponding guiding slot 31.

In order to drive the sleeve 3 from the extreme back-and-forth position to the percolation position, the lever 5 comprises a drive prong 32 which is adapted to be thrust against a stop surface 33 of the sleeve 3 when the latter is in its extreme back-and-forth position and when the lever 5 is in a closed position arranged between its release position and its intake position. This drive prong 32 makes it possible as such to drive the sleeve 3 from its extreme back-and-forth position to its percolation position when the activation member 5 passes from its closed position to its intake position. Here, the stop surface 33 is carried out at the second axial end of the sleeve 3 opposite that adjacent defining the ejection outlet 16, and, in parallel, the drive prong 32 is formed by a rear wing 32 of the lever 5 which is pendant from the actuating wing 25 and connects the two lateral wings 28.

Moreover, in the first embodiment, the lever 5 and the sleeve 3 are conformed in such a way that, when they are in percolation position, the sleeve 3 is locked in order to prevent it from reversing and providing the seal between the latter and the packing head 10 on the corresponding seal 13. More precisely, each lateral wing 28 comprises a backstop surface 34 against which is thrust an additional backstop surface 35 carried by the corresponding base 30; this putting into contact is carried out during the coming of the lever 5 in percolation position.

For the driving of the compression member 4, the lever 5 cooperates with at least one (here, two) rod 36. Each rod is mounted in rotation, on the one hand, around a first connecting shaft 37 carried by the lever 5, and, on the other hand, around a second connecting shaft 38 carried by the compression member 4. As such, when the lever 5 passes from its intake position to its percolation position, the compression member 4 passes from its intake position to its percolation position, and when the lever 5 passes from its percolation position to its intake position, the compression member 4 passes from its percolation position to its intake position. In these embodiments, for each rod 36, the main shaft 24 and the connecting shaft 38 carried by the compression member 4 forming a straight line 39 which is crossed by the connecting shaft 37 carried by the lever 5 when the compression member 4 is close to its percolation position, in such a way as to form a toggle joint. The lever 5 in percolation position is thrust against the base 2, which prevents the reversing of the compression member 4 during the percolation (the water being in general under a pressure close to 15 bars).

Moreover, in these embodiments, the connection between the lever 5 and the compression surface 18 is shaped in such a way that the percolation position of this surface 18 is adjusted to the quantity of grounds introduced into the percolation chamber (the percolation position of the lever 5 still being the same).

In the first embodiment, the compression member 4 comprises an injection nozzle 40 which forms the body of the compression member 4, and a packing sleeve 41 which carries the compression surface 18.

The packing sleeve 41 is mounted mobile in translation in relation to the injection nozzle 40 according to the axial direction between an extension position and a percolation position wherein it is farther away from the packing head 10 than in extension position and wherein it is thrust against the injection nozzle 40.

The injection nozzle 40 carries the second connecting shaft 38 and comprises the water feed duct 20. It further comprises a cylindrical wall 42 which extends axially in the direction of the packing head 10 and of the compression surface 18 starting from the outlet orifice of the water feed duct 20. The cylindrical wall defines a water injection cavity exiting into a water chamber delimited by the packing sleeve 41.

The packing sleeve 41 comprises, in addition to the compression surface 18, an annular wall 43 which surrounds the front portion of the injection nozzle 40 (the front portion of the cylindrical wall 42) and which carries the seal 19 (here, on the compression surface 18). Moreover, the annular wall 43 has a passage slot 44 which allows for the sliding of the second connecting shaft 38 during the displacement of the packing sleeve 41 in relation to the injection nozzle 40.

In order to provide the seal of the connection between the injection nozzle 40 and the packing sleeve, in this example, the exterior surface of the cylindrical wall 42 comprises an annular groove wherein is mounted a seal 45 which is in contact with the interior face of the annular wall 43.

In addition, in this example, the packing sleeve 41 is solicited in its extension position by an elastic element 46 (a spring 46) which presses on the packing sleeve 41 and on the injection nozzle 40. Here, the spring 46 is a helical spring which surrounds the injection nozzle 40 (the cylindrical wall 42) and which is surrounded by the packing sleeve 41 (the annular wall 43). More precisely, the cylindrical wall 42 of the injection nozzle 40 comprises an annular shoulder 47 protruding towards the exterior, and in parallel, the annular wall 43 comprises an annular wall 48 facing the annular shoulder 47, with the latter and the annular wall 48 serving as support for the spring 46.

In the second embodiment, the connection between the lever 5 and the compression member 4 is shaped in such a way that the percolation position of the compression member 4 is adjusted to the quantity of grounds introduced into the percolation chamber (the percolation position of the lever 5 still being the same).

In the second embodiment, one 37 of the two connecting shafts 37, 38 (here, the connecting shaft 37 carried by the lever 5) is mounted slidingly in two oblong slots 49. As such, this shaft 37 is mobile between an advanced position which corresponds to a small quantity of grounds introduced into the percolation chamber, and a retracted position which corresponds to a substantial quantity of grounds. Furthermore, the shaft mobile 37 is solicited in its advanced position by an elastic element 50 (here an adjustment spring 50 which is housed in a cavity 51 carried out in the lever 5 and crossed by the oblong slot 49) pressing against the shaft 37 and the lever 5.

In the second embodiment, in order to prevent the reversing of the compression member 4 during the percolation (the water is in general under a pressure close to 15 bars and can reach 19 bars) when the compression member 4 and the lever 5 are in their percolation position, each rod 36 (on the connecting shaft 37 carried by the activation member 4) comprises stop members 52 (here, catches 52) which are thrust against additional stop members 53 (here, catches 53) of a support element 54 fixed to the casing 9. As such, in this second embodiment, the adjustment of the position of the compression member 4 is maintained during the percolation.

Moreover, in the first embodiment, the compression member 4 is adapted in order to allow for a drying out of the grounds once the percolation is complete.

As such, in this embodiment, the elastic connector between the compression surface 18 (carried by the packing sleeve 41) and the injection nozzle 40 makes it possible, when the percolation is completed and the water pump stopped, to again compress the grounds used. Therefore, the water that was previously located between the grounds and the compression surface 18 as well as a portion of the water contained in the grounds again passes through the compression surface 18 and penetrates into the compression member 4 (in the water injection chamber and in the water cavity).

In the first embodiment, the injection nozzle 40 is moreover conformed in such a way as to make possible, on the one hand, the evacuation of the water which penetrates again into the compression member 4, and, on the other hand, to improve the drying out of the grounds by sucking a quantity of water which is still present there despite the compression of the packing sleeve 41 at the end of percolation.

More precisely, the injection nozzle 40 comprises an injection bushing 55 which forms the main body of the injection nozzle 40, and a valve 56 which is mounted mobile in translation in relation to the injection bushing 55 according to the axial direction between a closed position and an opened position.

In this example, the injection bushing 55 comprises the cylindrical wall 42 of the injection nozzle 40 and the water feed duct 20 and carries the second connecting shaft 38. It interiorly delimits the water injection cavity wherein the valve 56 is mounted slidingly. Furthermore, the cylindrical wall 42 is crossed by an evacuation passage 57 made in the lower angular sector (in such a way as to be located at the lowest point when the percolation device 1 is correctly arranged on a countertop) and communicating with a recovery tray for water at atmospheric pressure. This evacuation passage 57 is obstructed by the valve 56 when the latter is in its closed position, and is released when it is in its opened position.

The valve 56 is arranged between the outlet of the water feed duct 20 and the water chamber and is shaped in such a way as to be able to be driven from its opened position to its closed position by the water exiting from the water feed duct 20 which still allows for the supply in water of the percolation chamber. More precisely, it comprises an upstream axial wall 58 which faces the water feed duct 20 and which allows the water exiting therefrom under pressure to drive it in its closed position. It is moreover crossed by a channel 59 allowing for the passage of the water from the water feed duct 20 to the compression surface 18, the section of the channel 59 being of a low section in relation to that of the upstream axial wall 58 in such a way as to allow for the displacement of the valve 56. Moreover, the straight section of the valve 56 corresponds to that of the water evacuation cavity in such a way that its translation movement is its only degree of freedom.

In this embodiment, the opened position of the valve 56 is defined by the thrusting of its upstream axial wall 58 against the water feed duct 20. Its closed position is defined by the thrusting of the valve 56 against an annular stop surface 60 carried out at the interior surface of the cylindrical wall 42 of the injection bushing 55 (here, this entails the thrusting of an annular stop wall 61 which is carried by the cylindrical surface of the valve 56 and which faces the annular stop surface 60).

The seal of the obstruction of the evacuation passage 57 via the valve 56 in closed position is provided with regards to the water located between the water evacuation duct 20 and the upstream axial wall 58 of the valve 56, as well as with regards to the water located in the water chamber and in the downstream portion of the water injection cavity (downstream of the valve 56). To this effect, there are two O-ring seals 62, 63 arranged between the valve 56 and the injection bushing 55, these two seals 62, 63 being arranged axially on either side of the evacuation passage 57. In this example, the downstream O-ring seal 62 is arranged in a housing made at the intersection of the annular stop wall 61 with the exterior cylindrical surface of the valve 56. This seal 62 is deformed and hugs the form of the annular stop surface 60 of the injection bushing 55. The upstream O-ring seal 63 is arranged in a groove made in the exterior cylindrical surface of the valve 56, and is in contact with the internal surface of the cylindrical wall 42 of the injection bushing 55.

Furthermore, in this example, the valve 56 is solicited in its opened position by an elastic element 64 (here, a spring 64) which presses on the valve 56 and on the injection bushing 55. Here, the spring 64 is a helical spring which surrounds the valve 56 (its downstream portion) and which is surrounded by the injection bushing 55 (the cylindrical wall 42). More precisely, the exterior surface of the valve 56 comprises an annular support shoulder 65, and in parallel, the cylindrical wall 42 comprises an annular support wall 66 facing the annular support shoulder 65, with the latter and the annular support wall 66 used as a support for the spring 64.

Furthermore, in the second embodiment, so that the seal 19 is effective during the percolation without however generating substantial friction with the cylinder 17 during the displacement of the compression member 4, the latter can be conformed between a state of displacement wherein the seal 19 is compressed according to a first intensity and a state of percolation wherein it is compressed according to a second intensity that is stronger than the first. The more substantial the compression intensity of the seal 19 is, the more it protrudes radially beyond the peripheral surface of the compression member 4, the more the contact surface with the sleeve 3 is substantial, and the more the seal is also substantial.

As such, in the second embodiment, the compression member 4 comprises, in addition to the seal 19, a piston 67 which forms the body of the compression member 4, and a clamping sleeve 68.

The piston 67 as such comprises the system for injecting water under pressure (including the compression surface 18 with the sprayer and the water feed duct 20) and carries the second connecting shaft 38. Moreover, it further comprises an annular peripheral shoulder 69.

Likewise, the clamping sleeve 68 which, here, surrounds the rear portion of the piston 67, carries an additional annular peripheral shoulder 70 forming the axial end of the clamping sleeve 68 adjacent to the packing head 10. The additional annular peripheral shoulder 70 defines with the annular peripheral shoulder 69 of the piston 67 the groove wherein is housed the seal 19. The clamping sleeve 68 is mounted movable in relation to the piston 67 between a loosening position wherein the compression member 4 is in its state of displacement, and a clamping position wherein the compression member 4 is in its state of percolation, the space separating the additional annular peripheral shoulder 70 from the annular peripheral shoulder 69 being smaller when the clamping sleeve 68 is in its clamping position than when it is in its loosening position, which drives a radial extension of the seal 19. At an identical position of the piston 67, the sleeve is closer to the packing head 10 when it is in clamping position than when it is in loosening position.

Furthermore, the compression member 4 and the connection between this member and the activation member 5 (here, the two rods 36) cooperate in such a way that the compression member 5 is in its state of displacement when it passes from its percolation position to its intake position and from its intake position to its percolation position (and, here, when it is in its intake position), and is in its state of percolation when it is in its percolation position. As such, the connection between the activation member 5 and the compression member 4 is itself adapted to drive the change in state of the compression member 4, and therefore the displacement of the clamping sleeve 68 in relation to piston 67.

Here, the second connecting shaft 38 is carried by the piston 67 and the clamping sleeve 68 comprises, at its axial surface opposite that formed by the additional annular peripheral shoulder 70, at least one (here, two) cam surface 71. Each cam surface 71 is adapted to receive the longitudinal end 72 of a corresponding rod 36 adjacent to this second shaft 38. As can be seen in FIG. 3, here, each longitudinal end 72 drives the corresponding cam surface 71 when the compression member 4 arrives (is) in percolation position (during the crossing of the straight line 39 or after the crossing of the latter).

Relating to the driving of the ejector 6, in the first two embodiments, the lever 5 comprises an actuating member 73 which is mobile entre an actuating position and an activated position. In these embodiments, the actuating member 73 is solicited in its actuating position by an elastic member 74.

When the lever 5 is in its percolation position as well as when it is in its intake position, the actuating member 73 is in its actuating position. During the displacement of the lever 5 from its intake position to its percolation position, the actuating member 73 is driven by the ejector 6 in its activated position and returns to its actuating position once the ejector 6 is crossed. On the contrary, during the displacement of the lever 5 from its percolation position to its intake position, the actuating member 73 remains in its actuating position, drives the ejector 6 from its idle position to its ejection position, with the latter returning to its idle position once the actuating member 73 has crossed it. As such, the lever 5 passes through an ejection position wherein the ejector 6 is in its ejection position, wherein the sleeve 3 is in its ejection position, and wherein the compression member 4 has reached the ejection outlet 16 in such a way that all of the grounds are located in line with the discharge outlet 8.

In the first two embodiments, as can be seen in FIG. 8, the actuating member 73 is formed by a lug 73 located at the free end of a lateral tab 74 which is elastically deformable and which is fixed in an immobile manner to the actuating wing 25. The lug 73 is adapted to cooperate with a finger 75 of the ejector 6. The corresponding contact surfaces of the lug 73 and of the finger 75 are shaped in such a way that the crossing of the finger 75 is carried out by the consecutive snapping of the lug 73, and that, in the direction of the displacement of the activation member 5, the lug 73 is thrust against the lower surface of the finger 75 and drives the latter.

Here, the ejector 6 is a one-piece part comprising the ejection prong 22 which is arranged mainly in the casing 9, the finger 75 which is arranged to the exterior of the casing 9 and a rotating shaft 76 (parallel to the axis of the cylinder 17) which forms the axis of rotation of the ejector 6. Here, the rotating shaft 76 is housed in the thickness of the casing 9 and the ejection prong 22 crosses the casing 9 in such a way as to include an extension 77 protruding to the exterior beyond the axis of rotation, and to which is fixed the return spring 21.

In the third embodiment shown in FIG. 14, the sleeve 3 carries an actuating member 78 which is adapted to cooperate with the ejector 6 in such a way that, when the sleeve 3 is in its percolation position, the ejector 6 is in its idle position, and when the sleeve 3 is in its ejection position, the ejector 6 is in its ejection position. In this embodiment, the actuating member 78 is formed by a rib 78 which extends longitudinally along the sleeve 3 and which forms a cam surface having a variable radial dimension. The finger 75 is solicited in its idle position wherein it is thrust against the rib 78 in such a way that the translation movement of the sleeve controls the movement of rotation of the ejector 6 around its rotating shaft 76.

As such, in use, in order to obtain a drink of coffee, starting with the lever 5 in intake position, a user introduces the coffee grounds into the percolation chamber via the grounds introduction inlet 7 and the grounds intake outlet 15 which extends the latter. A this instant, the sleeve 3 is in percolation position, the compression member 4 is in intake position and in a state of displacement (in the first embodiment, the packing sleeve 41 is in its extension position and the valve 56 is in its opened position, and in the second embodiment, the clamping sleeve 68 is in loosening position) and the ejector 6 in idle position.

Then, the user drives the lever 5 towards its percolation position. During this displacement, the compression member 4 (in the state of displacement) is driven towards its percolation position. During this displacement, on the one hand, the actuating member 73 (the lug 73) crosses the ejector 6 (the finger 75) without displacing it, and, on the other hand, the selective fixing members 26 (the ribs 26) cross the additional selective fixing members 27 (the lugs 27) without displacing the sleeve 3. During these crossings, the additional selective fixing members 27 (the lugs 27) snap with the selective fixing members 26 (the ribs 26) and, in the first two embodiments, the actuating member (the lug 73) snaps with the ejector 6 (the finger 75).

The immobilisation of the compression surface 18 of the compression member 4 in its percolation position due to the presence of the grounds occurs when the lever 5 is in a locked position which depends on the quantity of grounds introduced.

By continuing the movement of the lever 5, in the first embodiment, the packing sleeve 41 generates a force against the spring 46 which makes it possible to adjust the relative position of the injection nozzle 40 in relation to the packing sleeve 41 which is then in an adjusted packing position; in the second embodiment, the compression member 4 (the piston 67) generates a force against the adjustment spring 50 (via the second connecting shaft 38, the rods 36 and the first connecting shaft 37) making it possible as such to adjust the percolation position of the compression member 4 to the quantity of grounds. Simultaneously, the first connecting shaft 37 crosses the straight line 39, and, in the second embodiment, the stop members 52 (the catches 52) of the rods 36 are thrust against the additional stop members 53 (the catches 53) of the supporting member 54. Moreover, in the second embodiment, once the straight line 39 is crossed by the first connecting shaft 37, in the first embodiment, the longitudinal end 72 of each rod 36 comes into contact against the corresponding cam surface 71 of the clamping sleeve 68 and drives the latter in its clamping position. Furthermore, in the various embodiments, at the end of travel of the lever 5, the backstop surfaces 34 of the latter come to slide against the additional backstop surfaces 35 of the sleeve 3 (of the bases 30).

Once the lever 5 is in percolation position, the user can trigger the production of the drink. Just before the triggering, the sleeve 3 and the compression member 4 are in percolation position (in the first embodiment, the packing sleeve 41 is in its adjusted packing position and the valve 56 is in its opened position, and in the second embodiment, the clamping sleeve 68 is in clamping position) and the ejector 6 is in idle position.

Once the pump is activated, the water passes through the water feed duct 20, crosses the compression member 4 by passing through the sprayer, and reaches the percolation chamber where the coffee is made which escapes therefrom via the drink evacuation duct 12.

In the first embodiment, when the water under pressure exits from the water feed duct 20, it is thrust against the valve 56, drives it in its closed position and compresses the corresponding spring 64. The water crosses the valve 56 via the channel 59, then the downstream portion of the injection bushing 55, and the compression surface 18 of the packing sleeve 41. Due to the increase in the pressure in the percolation chamber, the packing sleeve 41 undergoes a reverse movement in the direction of its percolation position, which compresses the spring 46. The space between the compression surface 18 and the grounds is then filled with water under pressure, this space being more or less substantial according to the quantity of grounds introduced and to the percolation pressure (which depends on the grounds). Therefore, in the first example, the adjustment of the compression surface 18 to the quantity of grounds takes place only during the packing of the grounds, before the injection of the water, the grounds remaining however packed during the entire duration of the percolation.

Once the drink is obtained, the pump is stopped, which drives the stopping of the supply in water of the compression member 4. Consequently, in the first embodiment, due to the difference in pressure present on either side of the valve 56, the spring 64 drives the latter in its opened position wherein the evacuation passage 57 is cleared. As such, the pressure present in the injection bushing 55 is equal to that present in the recovery tray (the atmospheric pressure), which drives the aspiration of the water contained in the percolation chamber and its evacuation via the evacuation passage 57. Simultaneously, the decrease in the pressure in the percolation chamber allows the spring 46 to drive the packing sleeve 41 in its adjusted packing position, which makes it possible to compress the used grounds and to optimise its drying out. Note that the water located downstream of the pump, in the water evacuation duct is also sucked. Therefore, during the realisation of the next drink, the water will be hot right from the first drops.

Then, the user brings the lever 5 towards its intake position. At the beginning of this displacement, in these embodiments, the backstop surfaces 34 of the lever 5 release the additional backstop surfaces 35 of the sleeve 3, and, in the second embodiment, on the one hand, the stop members 52 (the catches 52) of the rods are released from the additional stop members 53 (catches 53) of the supporting member 54, and, on the other hand, the longitudinal end 72 of each rod 36 releases the corresponding cam surface 71 of the clamping sleeve 68.

During the displacement of the lever 5 (once the additional backstop surfaces 35 released), the additional selective fixing members 27 (the lugs 27) are thrust against the selective fixing members 26 (the ribs 26) then are driven by the latter, which generates the displacement of the sleeve 3 from its percolation position to its extreme back-and-forth position.

Moreover, in the first embodiment, during the displacement of the lever 5, the injection nozzle 40 is reversed, and, therefore, the spring 46 drives the packing sleeve 41 in its extension position. In the second embodiment, once the rods 36 are released from the supporting member 54, during the displacement of the lever 5, the adjustment spring 50 drives the displacement of the first connecting shaft 37 in its advanced position, and, once this position is reached, the lever 5 drives the displacement of the compression member 4 and, through the force of the events (due to the releasing of the clamping sleeve 68), the displacement of the clamping sleeve 68 towards its loosening position.

Due to the reverse movement of the sleeve 3, the discharge outlet 8 is released progressively. In addition, due to the shape of the selective fixing members 26 (ribs 26) and the arrangement of the rods 36, the sleeve 3 retracts before the compression member 4 in such a way that the grounds are located outside of the sleeve 3, in line with the discharge outlet 8.

In the first two embodiments, during the displacement of the lever 5, in a first step, the actuating member 73 is without contact with the ejector 6 (with the finger 75), then is thrust against it and rapidly drives its rotation until in its ejection position; beyond its ejection position, the lever 5 (the actuating member 73) releases the ejector 6 which returns to its idle position due to the return spring 21. In the third embodiment, during the displacement of the sleeve 3 towards its extreme back-and-forth position, the actuating member 78 (the rib 78) receives via thrust the ejector 6 (the finger 75) and drives it into its ejection position. The ejection of the grounds is further facilitated and clean when the latter has been dried.

Moreover, by continuing the displacement of the lever 5, the sleeve 3 is directed towards its extreme back-and-forth position and the compression member 4 towards its intake position. When the lever 5 is in its release position, each additional selective fixing member 27 (each lug 27) crosses the longitudinal end 29 of the selective fixing member 26 (the rib 26) and is released from the latter. The sleeve 3 is then immobile until the lever 5 reaches its closed position, starting from which the drive prong 32 drives the sleeve 3 towards its percolation position, the compression member 4 being moreover still driven towards its intake position. During this movement, in the third embodiment, the return spring 21 solicits the ejector 6 (the finger 75) in such a way that the latter follows the curve of the actuating member 78 (the rib 78) to return to its idle position.

When the lever 5 reaches its intake position, the sleeve 3 reaches its percolation position and the compression member 4 its intake position.

As such, via two particularly simple movements (driving a lever in one direction then in the other), the user can obtain a coffee obtained by percolation, using loose grounds.

This invention is not limited to this embodiment. It would as such be possible for the movement of the activation member to be inversed: so that it is lowered in order to allow for the introduction of the grounds and is raised in order to compress them. It would also be possible for the lever to be motorised, which would then make it possible to automate the movements of the percolation device without the intervention of the user (other than the triggering by the activation of a manual control such as a button). Furthermore instead of using a compression member with a piston and a clamping sleeve in order to provide a good seal without the displacement being hindered by substantial friction, it would be possible to use a lip seal. In addition, the packing head could be movable in relation to the casing.

This invention further relates to other objects than the one covered by the set of claims. It as such relates to:
a percolation device for loose grounds, comprising a packing head, a compression member which is mounted mobile in a compression chamber between an intake position and a percolation position wherein it is closer to the packing head than when it is in its intake position, and which comprises a compression surface delimiting axially, in the compression chamber, with the packing head, a percolation chamber, and an activation member which is adapted to displace the compression member from one of its positions to another, the connection between the activation member and the compression surface being conformed in such a way that the percolation position of the latter is adjusted to the quantity of grounds introduced into the percolation chamber;
a percolation device for loose grounds, comprising a sleeve delimiting a compression chamber, and a compression member which is provided with a seal providing the seal with the sleeve, and which is mounted mobile in the compression chamber between an intake position and a percolation position, the compression member able to be conformed between a state of displacement wherein the seal is compressed according to a first intensity and a state of percolation wherein it is compressed according to a second intensity that is stronger than the first in such a way as to increase the seal; and
a percolation device for loose grounds, comprising a packing head delimiting a compression chamber which is accessible from the exterior in order to allow for the introduction of loose grounds and their expulsion, and a compression member which is mounted mobile in the compression chamber between an intake position and a percolation position, the compression member being shaped in such a way as to be able to evacuate a portion of the water contained in the percolation chamber before the ejection of the grounds.

Each of these objects can further include one or the other of the aforementioned characteristics, or a combination of them.

1. A percolation device comprising a percolation chamber for percolating loose coffee grounds, the device comprising:
a base wherein is provided a discharge outlet (8) for expulsing percolated grounds out of the percolation chamber,
a sleeve mobile according to an axial direction between at least one percolation position and an ejection position wherein the sleeve respectively obstructs and releases the discharge outlet, the sleeve comprising an axial ejection outlet for expulsing the grounds out of the percolation chamber,
a packing head adjacent to the ejection outlet and axially delimiting the percolation chamber and the discharge outlet,
a compression member having a compression surface which axially delimits the percolation chamber opposite the packing head, the compression member being mobile axially between an intake position and a percolation position wherein said compression member is closer to the packing head than when said compression member is in the intake position, and
an activation member mobile between an intake position and a percolation position,
characterised in that the activation member is formed by a lever which is adapted to movably drive differently the sleeve and the compression member in such a way that, when the sleeve is in the ejection position, the grounds are in line with the discharge outlet by being driven out of the sleeve via the ejection outlet, by the compression surface.

2. The percolation device according to claim 1, characterised in that the lever (5) drives the sleeve (3) in a back-and-forth movement starting from the percolation position by passing through the ejection position when said lever passes from the percolation position to the intake position.

3. The percolation device (1) according to claim 2, characterised in that the lever (5) comprises an selective fixing member (26) adapted to cooperate with an additional selective fixing member (27) carried by the sleeve (3) in such a way that, when the lever (5) passes from the percolation position to a release position located between the percolation position and the intake position, the additional selective fixing member (27) is fixed to the selective fixing member (26) and drives the sleeve (3) from the percolation position to the extreme back-and-forth position wherein the additional selective fixing member (27) is released from the selective fixing member (26), and in such a way that when the lever (5), reaches the percolation position from the intake position, the additional selective fixing member (27), previously released from the selective fixing member (26), is fixed to said lever.

4. The percolation device (1) according to claim 3, characterised in that the lever (5) comprises a drive prong (32) adapted to be thrust against the sleeve (3) in the extreme back-and-forth position when the lever (5) is in a closed position arranged between the release position and the intake position, and to drive the sleeve (3) from the extreme back-and-forth position to the percolation position when the lever (5) passes from the closed position to the intake position.

5. (canceled)

6. (canceled)

7. The percolation device (1) according to claim 1, characterised in that the lever (5) comprises a backstop surface (34) adapted to be thrust against an additional backstop surface (35) of the sleeve (3) when the lever (5) and the sleeve (3) are in the percolation position in such a way as to prevent the displacement of the sleeve (3) during the percolation.

8. The percolation device (1) according to claim 7, characterised in that the additional backstop surface (35) is carried by the base (30).

9. The percolation device (1) according to claim 1, characterised in that the lever (5) leaves the sleeve (3) in the percolation position when said lever passes from the intake position to the percolation position.

10. The percolation device (1) according to claim 1, characterised in that the lever (5) drives the compression member (4), on the one hand, from the intake position to the percolation position when the lever passes from the intake position to the percolation position, and, on the other hand, from the percolation position to the intake position when the lever passes from the percolation position to the intake position.

11. The percolation device (1) according to claim 1, characterised in that the connection between the lever (5) and the compression member (4) is a toggle joint and comprises at least one rod (36) mounted in rotation, on the one hand, around a first connecting shaft (37) carried by the lever (5), and, on the other hand, around a second connecting shaft (38) carried by the compression member (4), the main shaft (24) by which the lever (5) is connected to the base (2) and the connecting shaft (38) carried by the compression member (4) forming a straight line (39) which is crossed by the connecting shaft (37) carried by the lever (5) when the compression member (4) is close to the percolation position.

12. The percolation device (1) according to claim 1, characterised in that the connection between the lever (5) and the compression surface (18) is shaped in such a way that the percolation position of the latter is adjusted to the quantity of grounds introduced into the percolation chamber.

13. The percolation device (1) according to claim 11, characterised in that:
one (37) of the two connecting shafts (37, 38) is mounted slidingly in an oblong slot (49) between an advanced position and a retracted position and is solicited in the advanced position by an elastic element (50) in such a way as to adjust the percolation position of the compression member (4), and,
the connection between the lever and the compression surface is shaped in such a way that the percolation position of the compression surface is adjusted to the quantity of grounds introduced into the percolation chamber.

14. (canceled)

15. (canceled)

16. (canceled)

17. The percolation device (1) according to claim 11, characterised in that:
the compression member (4) comprises, on the one hand, an injection nozzle (40) which carries the second connecting shaft (38), and, on the other hand, a packing sleeve (41) which carries the compression surface (18) and which is mounted mobile in relation to the injection nozzle (40) between a percolation position and an extension position wherein the packing sleeve is closer to the packing head (10) than in percolation position, and,
the connection between the lever and the compression surface is shaped in such a way that the percolation position of the compression surface is adjusted to the quantity of grounds introduced into the percolation chamber.

18. (canceled)

19. The percolation device (1) according to claim 1, characterised in that the compression member (4) comprises a seal (19) which is adapted to provide the seal with the sleeve (3), the compression member (4) able to be conformed between a state of displacement wherein the seal (19) is compressed according to a first intensity and a state of percolation wherein the seal is compressed according to a second intensity that is stronger than the first in such a way as to increase sealing, the compression member (4) being in the state of displacement when the lever is displaced between its intake position and the percolation position, and in the state of percolation when the lever is in the percolation position.

20. The percolation device (1) according to claim 19, characterised in that the compression member (4) comprises, on the one hand, a piston (67) carrying the compression surface (18) and an annular peripheral shoulder (69), and, on the other hand, a clamping sleeve (68) carrying an additional annular peripheral shoulder (70) which defines with the annular peripheral shoulder (69) a groove wherein is housed the seal (19), the clamping sleeve (68) being mounted movable in relation to the piston (67) between a clamping position wherein the compression member (4) is in the state of percolation, and a loosening position wherein said compression member is in the state of displacement.

21. The percolation device (1) according to claim 20, characterised in that the connection between the lever (5) and the compression member (4) is adapted to drive the displacement of the clamping sleeve (68) in relation to piston (67).

22. (canceled)

23. The percolation device (1) according to claim 1, characterised in that the compression member (4) is shaped in such a way as to be able to evacuate a portion of the water contained in the percolation chamber before the ejection of the grounds via a difference in pressure.

24. The percolation device (1) according to claim 23, characterised in that the compression member (4) comprises, on the one hand, an injection bushing (55) which is crossed by an evacuation passage (57) and which connects in a sealed manner a water feed duct (20) to the compression surface (18), and, on the other hand, a valve (56) which is mounted mobile in relation to the injection bushing (55) between a closed position and an opened position wherein the valve respectively obstructs and releases the evacuation passage (57).

25. (canceled)

26. (canceled)

27. (canceled)

28. (canceled)

29. The percolation device (1) according to claim 1, characterised in that it comprises an ejector (6) which is mounted mobile between an idle position and an ejection position wherein said ejector ejects the grounds out of the percolation chamber via the discharge outlet (8).

30. The percolation device (1) according to claim 29, characterised in that the ejector (6) is solicited in the idle position by a return spring (21).

31. The percolation device (1) according to claim 29, characterised in that the displacement of the ejector (6) is driven by the lever (5) in such a way that, when the latter passes from the percolation position to the intake position, said lever drives the ejector (6) in the ejection position wherein the sleeve (3) is in the ejection position and wherein the grounds, driven out of the sleeve (3) by the compression surface (18), are in line with the discharge outlet (8).

32. (canceled)

33. (canceled)

34. (canceled)

35. (canceled)

36. (canceled)

37. (canceled)

38. The percolation device (1) according to claim 31, characterised in that the sleeve (3) carries an actuating member (78) which is adapted to drive the ejector (6) in the ejection position when the sleeve (3) is in the ejection position.

39. The percolation device (1) according to claim 38, characterised in that the actuating member (78) is adapted to cooperate with the ejector (6) in such a way that, when the sleeve (3) is in the percolation position, the ejector (6) is in the idle position, and when the sleeve is in the ejection position, the ejector (6) is in the ejection position.

40. (canceled)

41. A percolation device for loose grounds, comprising a packing head, a compression member which is mounted mobile in a compression chamber between an intake position and a percolation position wherein it is closer to the packing head than when it is in its intake position, and which comprises a compression surface delimiting axially, in the compression chamber, with the packing head, a percolation chamber, and an activation member which is adapted to displace the compression member from one of its positions to another, the connection between the activation member and the compression surface being conformed in such a way that the percolation position of the latter is adjusted to the quantity of grounds introduced into the percolation chamber.

42. A percolation device for loose grounds, comprising a sleeve delimiting a compression chamber, and a compression member which is provided with a seal providing the seal with the sleeve, and which is mounted mobile in the compression chamber between an intake position and a percolation position, the compression member able to be conformed between a state of displacement wherein the seal is compressed according to a first intensity and a state of percolation wherein it is compressed according to a second intensity that is stronger than the first in such a way as to increase the seal.

43. A percolation device for loose grounds, comprising a packing head delimiting a compression chamber which is accessible from the exterior in order to allow for the introduction of loose grounds and their expulsion, and a compression member which is mounted mobile in the compression chamber between an intake position and a percolation position, the compression member being shaped in such a way as to be able to evacuate a portion of the water contained in the percolation chamber before the ejection of the grounds.
